(19) United States
(12) Patent Application Publication
(10) Pub. No.: US 2005/0021433 A1
(43) Pub. Date: Jan. 27, 2005

(54) Diagnostics for agile infrastructure

(76) Inventor: Fletcher H. Hyler, Portola Valley, CA (US)

Correspondence Address: Jonathan O. Owens;Haverstock & Owens, LLP, 162 North Wolfe Road, Sunnyvale,, CA, 94086, US

(21) Appl. No.: 10/365,124

(22) Filed: Feb. 12, 2003

Related U.S. Application Data
(60) Provisional application No. 60/355,846, filed on Feb. 12, 2002.

(51) Int. Cl. G06F 17/60

(52) U.S. Cl. 705/36

(57) ABSTRACT

A framework for analyzing, predicting, and diagnosing the impact of application requirements upon information systems infrastructure requirements is disclosed. The framework combines two application parameters, the scope of the application and the use of the information of the application. The scope of the application is categorized as departmental, enterprise, and inter-company, while the use of the information is categorized as administration, process, and product. A new element, agility, is also used within the framework to maximize value, where agility is defined as time and cost required for changes in capacity, performance, functionality, availability, and manageability. Moreover, a set of diagnostics applicable to information systems for the measurement of the impact of insufficient agility within the information systems infrastructure is disclosed.

### RELATED APPLICATIONS

This Patent Application claims priority under 35 U.S.C. 119(e) of the co-pending U.S. Provisional Patent Application, Ser. No. 60/355,846, filed Feb. 12, 2002, and entitled, “DIAGNOSTICS FOR AGILE INFRASTRUCTURE,” and the disclosure of the above is incorporated herein by reference.

### BACKGROUND

1. Field of Invention

The invention relates to Information systems management, specifically the alignment and linkage between applications and infrastructure.

2. Related art

There have been descriptions of infrastructure using the metrics of:
Capacity
Performance
Functionality
Availability
Manageability
   But these traditional metrics have not included the increasingly critical metric of Agility. Additionally applications have been traditionally characterized in scope as being: Departmental, Enterprise, and Inter-company. While this categorization of application scope is important, by itself it is insufficient for predicting infrastructure requirements.

Information usage as a characterization for applications has been occasionally used on an ad hoc basis, but it has not been previously used as a continuum or in conjunction with the scope application attribute. The linkage of applications and infrastructure to date has been too vague and unsystematic for either achieving alignment or the impact and costs for the business of not having alignment with applications due to the lack of metrics,.
(a) Without the addition of Agility as an infrastructure element, a major cause of cost and impact was not included in any analysis.
(b) Without the combination of both application scope and information use, the primary drivers for application change, infrastructure needs and requirements could not be anticipated.
(c) Without the diagnostics, the impact on the business of not having alignment between applications and infrastructure could not be assessed.

The invention of the Framework for the Alignment of Applications and Infrastructure required both the new combination of the application characterization of scope [departmental, enterprise, inter-company], and the development of a new metric and diagnostics, and a new use of existing application categorization.

### SUMMARY

The present invention is a new framework to be used for analyzing, predicting, and diagnosing the impact of application requirements upon Information Systems infrastructure requirements.

In one aspect of the present invention, a method of developing a portfolio perspective of a plurality of applications implemented and planned comprises analyzing a degree of scope of the plurality of applications and analyzing an information usage of the plurality of applications. The method further comprises analyzing a cost associated with accommodating change. The degree of scope includes one of the following: departmental, enterprise, and inter-company, and the information usage includes one of the following: administrative usage, business process usage, and product value usage by a customer. The change may be an external systems event, an internal systems event, an external business event, or an internal business event. The external systems event includes at least one of: required change in software release, change in protocol by trading partner, and failure in external connected system. The internal systems event includes at least one of: addition to capacity, addition of new system, addition of new software, scheduled system backup, system unit failure, software failure, system reconfiguration, and new system implementation. The external business event includes at least one of: merger and acquisition, new trading partner, and new regulation. The internal business event includes at least one of: improvement to business process, enhancement to product value with information, enhancement to trading partner service, re-organization, cost reduction consolidation, and cost reduction integration.

In another aspect of the present invention, a method of anticipating infrastructure requirements for at least one planned application comprises analyzing an extent of application scope of the at least one planned application to predict at least one first prediction of infrastructure requirements and analyzing a use of information of the at least one planned application to predict at least one second prediction of infrastructure requirements. The at least one first prediction includes at least one of: increasing heterogeneity causing greater diversity of systems events, increased number of systems elements increasing a frequency of systems events, increased diversity of partner systems increasing a frequency of systems changes, increases in scope creating a need for continual application and systems integration, and an extension of the at least one planned application to additional internal departments and external trading partners increasing an impact of an outage, thereby increasing availability requirements. The at least one second prediction includes at least one of: each transition means more frequent change with less time available to address change in either systems or applications, each level increasingly requires faster systems response time which precludes a use of processes that are dependent upon intervention by personnel due to cost and time constraints, systems change is less deferrable due to a direct business profit impact.

In yet another aspect of the present invention, a framework for analyzing and dissecting applications into a plurality of common elements to serve as a common value proposition foundation for more cost-effective solution-selling by systems vendors comprises an application transition from departmental administrative to enterprise administrative that has similar application values and infrastructure resource requirements; an application transition from departmental administrative to departmental business process that has similar application values and infrastructure resource requirements; an application transition from departmental process to enterprise business process that has similar application values and infrastructure resource requirements; an application transition from departmental process to departmental product value that has similar application values and infrastructure resource requirements; an application transition from enterprise administrative to enterprise business process that has similar application values and infrastructure resource requirements; an application transition from enterprise administrative to inter-company administrative that has similar application values and infrastructure resource requirements; an application transition from departmental product value to enterprise product value that has similar application values and infrastructure resource requirements; an application transition from enterprise product value to inter-company product value that has similar application values and infrastructure resource requirements; an application transition from inter-company administrative to inter-company process that has similar application values and infrastructure resource requirements; an application transition from inter-company process to inter-company product value that has similar application values and infrastructure resource requirements; an application transition from enterprise process to enterprise product value that has similar application values and infrastructure resource requirements; an application transition from enterprise process to inter-company process that has similar application values and infrastructure resource requirements.

In yet another aspect of the present invention, a set of tools for assessing an effect of agility upon a cost effectiveness of an information system to meet at least one need of a business comprises a first analysis of a distribution of actual cost and amount of time to implement an infrastructure change over a period of time; a second analysis of how many problems had to be identified, managed, and optimized by people in an operation of information systems for last year's ten most potentially disruptive events; a third analysis of ratio of a cost of change to a cost of remaining constant; a fourth analysis of how many separate and sequential people are between awareness and implementation of change; a fifth analysis of how many scarce skill areas are involved between awareness and implementation of change; a sixth analysis of a percentage of time a specification changes more than 20 percent before it is implemented; a seventh analysis of how a first period of time required to identify a problem exceeds a second period of time required to fix the problem; and an eighth analysis of a number of times that a task cannot be done in time no matter how many people are added.

### BRIEF DESCRIPTION OF THE DRAWINGS

FIG. 1 shows a framework for an application portfolio analysis based on two attributes, scope of the application and information use of the application.

FIG. 2 shows the changes required in the infrastructure capabilities as the application and information use change.

FIG. 3A shows the evolution of an ERP application according to the present invention.

FIG. 3B shows the effect of the evolution of an ERP application on the framework, specific application, and required infrastructure capabilities.

FIG. 4 shows the dependency of applications on both the time available for information transfer and the network reconfiguration frequency.

FIG. 5 shows a distribution of change in costs and time.

FIG. 6 shows the dependence of the time to problem identification and the time to problem resolution on the increasing complexity of disconnected systems.

FIG. 7 shows the time required for task completion based on the number of personnel assigned for different agility infrastructures.

### DETAILED DESCRIPTION OF THE INVENTION

Development of the Framework

Applications have been traditionally characterized in scope as being: Departmental, Enterprise, and Inter-company. While this categorization of scope is important, by itself it is insufficient for predicting infrastructure requirements.

When coupled with the application characteristics relating to the information usage profile of the application the application infrastructure requirements become apparent: using the information for administration, using the information as an inherent element of the operations processes, and using the information as part of the product value seen and used by the customer.

While the information usage characterization for applications has been occasionally used on an ad hoc basis, it has not been previously used as a continuum or in conjunction with the scope application attribute. The vast majority of all application investments are efforts to either increase the Scope of the application [departmental, enterprise, inter-company], or the Use of the Information of the application [administration, process, product].

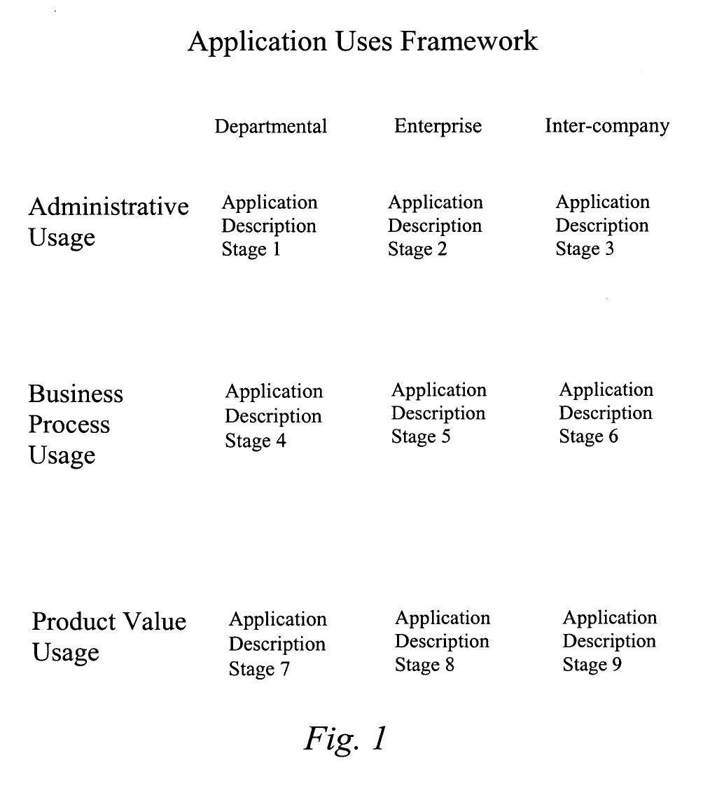

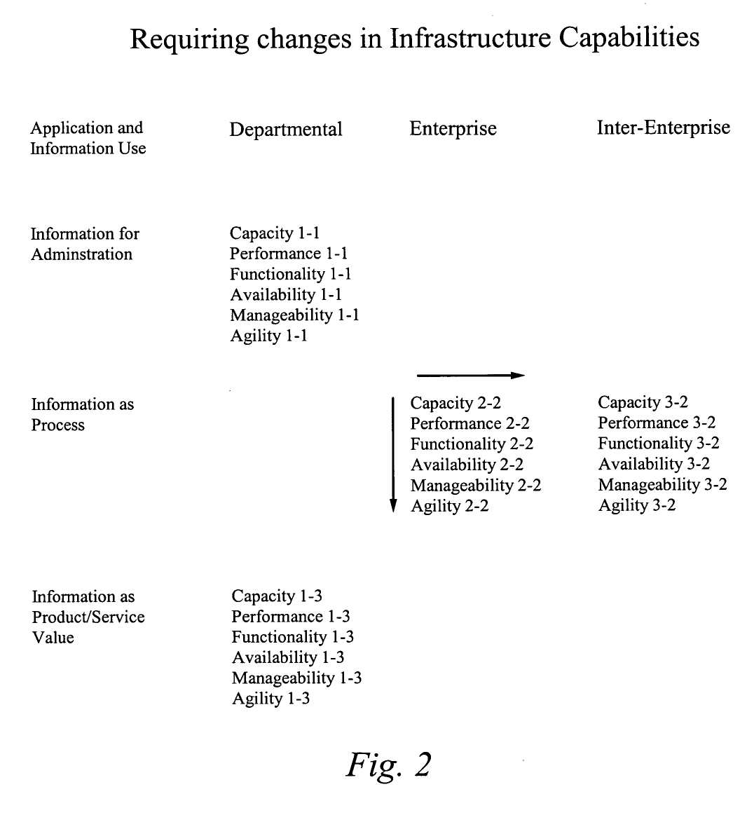

Combining these two application attributes for the first time provides the dimensions for an application portfolio analysis, as illustrated in FIG. 1, with the infrastructure requirements for each “state” being different. Indeed as the investment is made in the application, the infrastructure requirements change, as illustrated in FIG. 2.

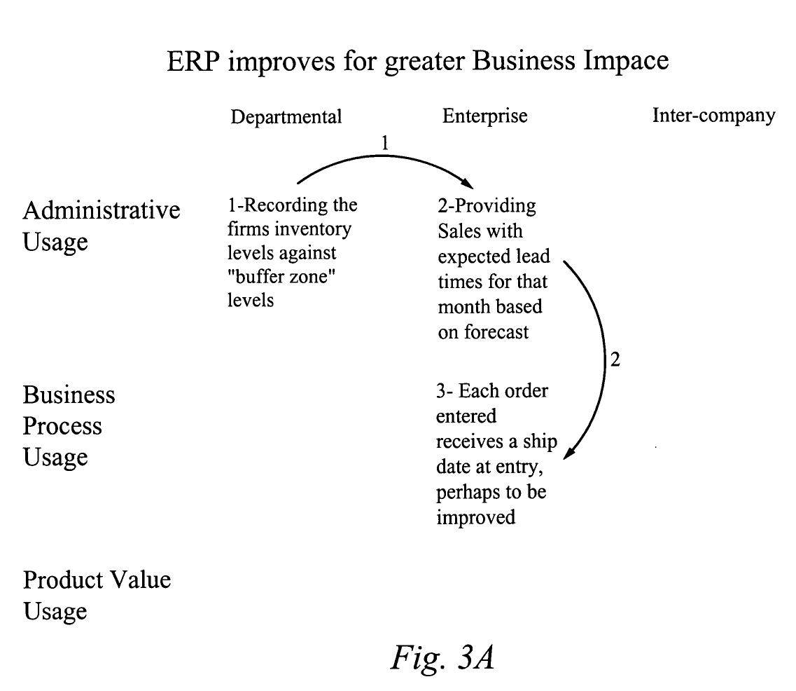

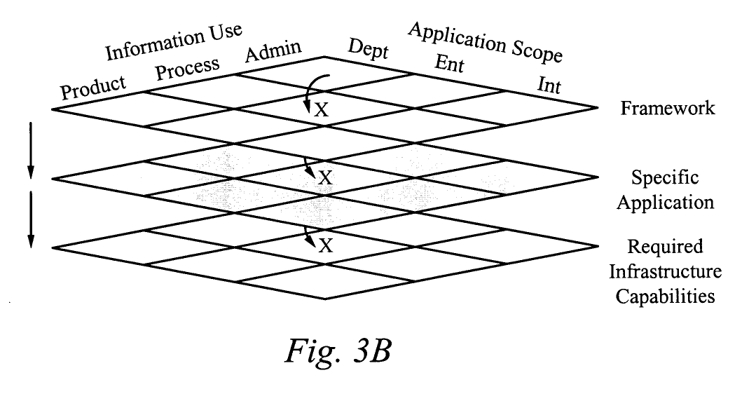

The unique combination of the two application attributes is sufficient for correlating the application state with infrastructure requirements. This Framework structure represents the reuse of the application scope attribute and uniquely combining it with the new “information use” attribute for application portfolio completeness. An example, using an ERP application, is illustrated in FIGS. 3A and 3B.

In FIG. 3A, arrow 1 indicates that the incorporation of inventory capacity into the expected customer delivery schedule helps Sales with customer expectations. Arrow 2 indicates that the ability for Sales to commit to ship schedules helps both selling and customer planning. The requirements for these application changes are predominantly increased availability and response time assurance, with increased capability to incorporate and manage heterogeneous systems. The evolution of this application to the Enterprise stage could occur for the incorporation of ship schedules for the sales department. Evolution to the Business Process Usage stage could occur for the ability for sales to make customer commitments at the time of the sale.

Additional Derived Framework For Networks

While the appropriate parameters for the Infrastructure Framework for Information Systems is Scope and information usage as described above, the Infrastructure Framework for Networks is slightly different.

For Networks the operational parameters for the Framework are Time Available for Information Transfer and Network Reconfiguration Frequency.

Time Available for Information Transfer:

This axis of the framework captures the amount of time available to transfer the information required by the application from the point of storage to the point of use. Some business uses and applications only require next day transfer, some same day, and others have transfer requirements of minutes or seconds! This axis is a continuum of application [business use] information transfer requirements ranging form multiple days to seconds.

Network Reconfiguration Frequency:

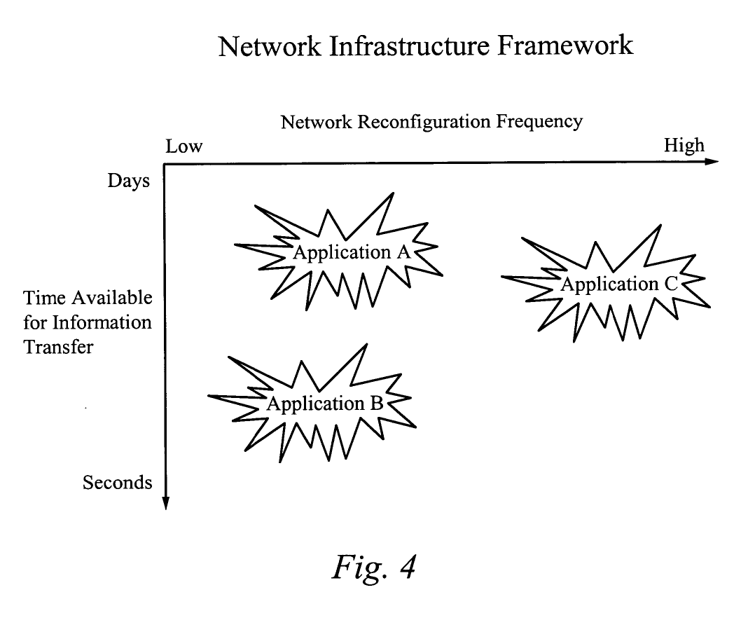

This axis of the framework captures the frequency that the configuration of the network needs to change in order to maintain alignment with the business operations requirements, as illustrated in FIG. 4. Reconfiguration includes:
changes in location that are served [or accessed] by the network,
changes in bandwidth provided by the network between locations
changes in security levels provided by the network between locations
changes in the protocols, standards, and technologies supported.

Also there are two new elements within this framework that are required for maximizing value:
The addition of the infrastructure metric of Agility, which has not been recognized previously because it played such a small role for departmental and enterprise administrative use applications. While Agility has been attributed to some applications before, the specific definition of agility as the first derivative of the historical attributes [‘time and cost require to change . . . ] is a new invention.
   Agility, which is defined as:
   Time and Cost required for changes in Capacity
   Time and Cost required for changes in Performance
   Time and Cost required for changes in Functionality
   Time and Cost required for changes in Availability
   Time and Cost required for changes in Manageability
      [i.e. the first derivative of the historical metrics]
The addition of a set of diagnostics which can be applied to IS for the measurement of the impact of insufficient agility within the IS infrastructure. This is critical since the agility attribute has only recently been realized and only just now defined.
   New Diagnostics invented for the IS Agility metric:
   (a) Distribution of actual cost [and time] per change

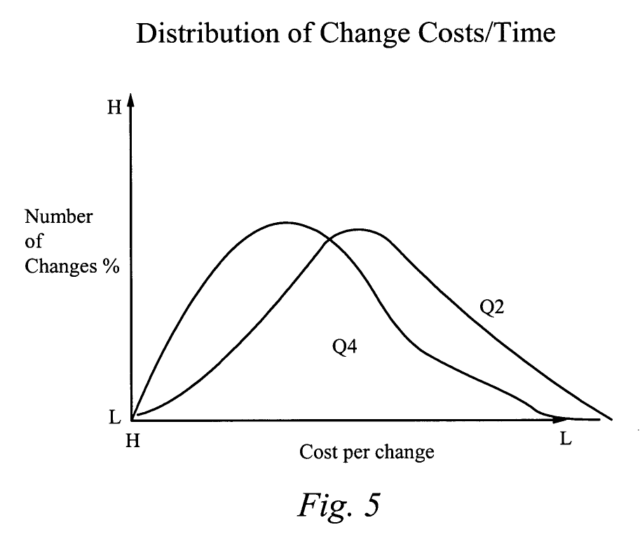

The distribution of time and cost for all changes within the firm, within a business process area. Assuming that the scope and complexity of change/enhancements are essentially the same over time, an increase in cost would indicate a decrease in agility alignment. An increase in time may also indicate a decrease in agility alignment unless the business has stabilized also. An exemplary distribution of change in costs and time is illustrated in FIG. 5.

(b) In the Operations of IS, for Last Years Top 10 Potentially Disruptive Events, how Many of the Issues had to be Identified, Managed, Optimized by People.

Words like “seamless” can be calibrated by looking at the specific events that occur in your company where “seamless” [ie. No disruption of applications and no intervention required] would be of value. Look at the last years events that were either disruptive or required intervention for an assessment of the seamless capabilities. Then try to anticipate next years changes if possible and repeat the process.

(c) The Ratio of “Cost of Change” to the “Cost of Constant” is Accelerating.

Every cost line item can be categorized as either a “cost of change” or as a “cost of constant”. The cost associated with a constant ongoing operation is a cost of constant, the cost associated with changes in operations, of either capacity or functionality, is a cost of change. For example in the area of personnel, the cost of salary would be a cost of constant while the cost of hiring or firing would be a cost of change. Insufficient agility determines the cost of change. If the business is constant there will be little cost of change. If the business is dynamic and the infrastructure is agile, the cost of change will be small. If the business is dynamic but the infrastructure is insufficiently agile, the cost of change will be high.

An agile infrastructure may actually be lower cost than one with simply an efficiency focus: the cost of managing a “pile of software” as part of a single system without a common architectural element; the cost of not having the right functionality in time for the business; and the cost of evolving a single element in an integrated system with all of the custom intertwining interfaces, which characterize integrated systems.

Diagnostics which may have Existed Previously, but not for the IS Agility Metric:

Number of separate and sequential people between awareness and implementation for changes.

Queue time constitutes the primary cause of all operation delays. By identifying the number of “hand offs” inherent in the process of implementing changes/enhancements we get a reasonable indicator of agility impediments.
Number of scarce skill areas involved between awareness and implementation for changes.

Another contributor to queue time is a backlog waiting for scarce skilled personnel to become available. The greater the skill requirements for a system the higher the probability that there will be a capacity constraint and agility will decrease. Skill scarcity can be measured by the number of days required to increase effective capacity.
Percentage of time the specification changes more than 20% before it is implemented.

In un-agile systems the implementation time is so long that the program is essentially obsolete by the time it is available. This because the rate of learning and evolution is so high that over 20% of the design and content should be changed before the initial system is completed. When IS says they can't go any faster, then mean “with the current system capabilities”. New organizations new tools, new approaches may all be required so that the initial system design is still relevant at the time of deployment.
How often does the time to identify the problem exceed the time to fix the problem?

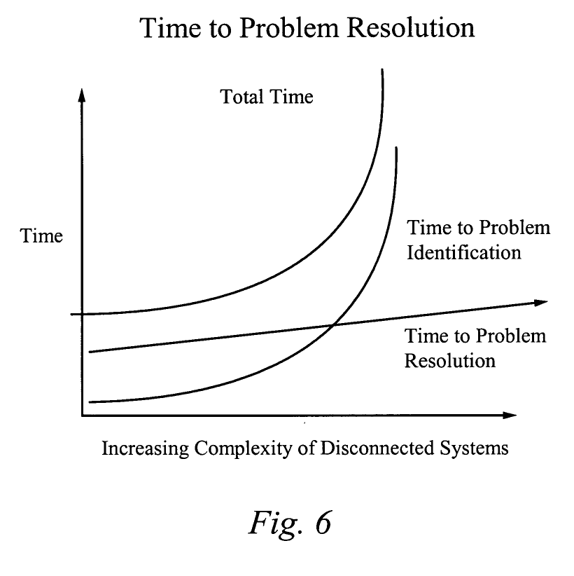

Complexity and un-connected multiple systems manifest themselves more in the time for problem identification than in time to problem, as illustrated in FIG. 6. The total time to problem resolution can increase exponentially based on the increase in “time to problem identification”, thereby reducing the overall systems agility.
Number of times that no matter how many people that could be added, the task expected cannot be done in time.

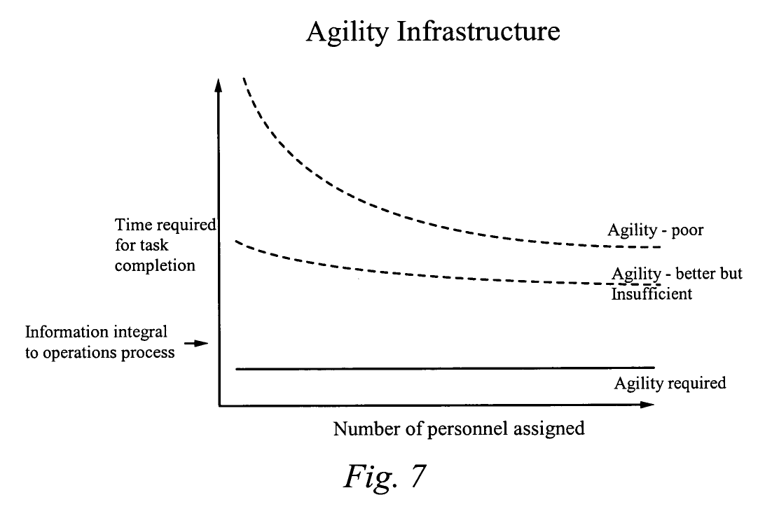

The agility of many infrastructures is usually dependent upon whether or not people are required to be involved in the identification or management of systems events/tasks, and the availability of the skill required. If people are involved in any of the processes, then minimum time may not be reduced below a certain response time level. The more people are required for either identification or management due to scale, heterogeneity, and diversity of application elements [such as wireless], the worse the agility and the greater the cost. If the task required [as shown in FIG. 7] requires a faster response time than can be provided regardless of the number of people assigned, then a new infrastructure is a requirement, not just a matter of IS costs. The diagnostic is to assess the time required for the most frequently expected tasks/events required by the application for the infrastructure configuration to assess both cost and sufficiency.

### OBJECTS AND ADVANTAGES

This framework and diagnostics provides several advantages to the Information Systems function within corporations:
The total cost of the Information Systems function can be significantly reduced by addressing the agility issue. The cost of change has become the dominant source of cost due to the lack of both awareness and metrics.
The ability to predict infrastructure requirements before application implementation will reduce the cost of responding to the IS “crisis” caused by application failure due to insufficient infrastructure capabilities.
Business managers will be more confident that IS can meet their needs and will become less resistant to applications that are integral to their business processes.
The total cost of application implementation will become clearer since the cost of required infrastructure capabilities can now be included.
Companies can now more cost effectively manage their portfolio of applications and the investment in enhancing that portfolio since the infrastructure impact is now visible.

This framework and diagnostics provides several advantages to Information Systems Vendors and consultants in the business of providing infrastructure capabilities:
Infrastructure Systems vendors [Sun, HP, Microsoft, IBM] will have a way of directly linking their capabilities to the requirements of the customers planned applications, thereby reducing the cost of sales.
Systems vendors selling applications can now bundle the required infrastructure capabilities into the project proposal.
As applications continue to evolve, the infrastructure requirements are better understood for improved product development.
Infrastructure Consulting firms can use the clients 3 year application plan to develop a 3 year infrastructure plan, which would cost less and provide better capabilities than the current ad hoc approach.

1-5. (canceled).

6. A method of developing a portfolio perspective of a plurality of applications implemented and planned, comprising:
a. analyzing a degree of scope of the plurality of applications; and
b. analyzing an information usage of the plurality of applications.

7. The method as claimed in claim 6, wherein the degree of scope includes one of: departmental, enterprise, and inter-company.

8. The method as claimed in claim 6, wherein the information usage includes one of: administrative usage, business process usage, and product value usage by a customer.

9. The method as claimed in claim 6 further comprising analyzing a cost associated with accommodating change.

10. The method as claimed in claim 9 wherein the change is an external systems event.

11. The method as claimed in claim 10 wherein the external systems event includes at least one of: required change in software release, change in protocol by trading partner, and failure in external connected system.

12. The method as claimed in claim 9 wherein the change is an internal systems event.

13. The method as claimed in claim 12 wherein the internal systems event includes at least one of: addition to capacity, addition of new system, addition of new software, scheduled system backup, system unit failure, software failure, system reconfiguration, and new system implementation.

14. The method as claimed in claim 9 wherein the change is an external business event.

15. The method as claimed in claim 14 wherein the external business event includes at least one of: merger and acquisition, new trading partner, and new regulation.

16. The method as claimed in claim 9 wherein the change is an internal business event.

17. The method as claimed in claim 16 wherein the internal business event includes at least one of: improvement to business process, enhancement to product value with information, enhancement to trading partner service, re-organization, cost reduction consolidation, and cost reduction integration.

18. A method of anticipating infrastructure requirements for at least one planned application, comprising:
a. analyzing an extent of application scope of the at least one planned application to predict at least one first prediction of infrastructure requirements; and
b. analyzing a use of information of the at least one planned application to predict at least one second prediction of infrastructure requirements.

19. The method of anticipating infrastructure requirements as claimed in claim 18 wherein an extent of application scope is intermediate between departmental and inter-company.

20. The method of anticipating infrastructure requirements as claimed in claim 19 wherein the at least one first prediction includes at least one of: increasing heterogeneity causing greater diversity of systems events, increased number of systems elements increasing a frequency of systems events, increased diversity of partner systems increasing a frequency of systems changes, increases in scope creating a need for continual application and systems integration, and an extension of the at least one planned application to additional internal departments and external trading partners increasing an impact of an outage, thereby increasing availability requirements.

21. The method of anticipating infrastructure requirements as claimed in claim 18 wherein the information usage includes at least one of: administration, part of operations process, and part of product value.

22. The method of anticipating infrastructure requirements as claimed in claim 20 wherein the at least one second prediction includes at least one of: each transition means more frequent change with less time available to address change in either systems or applications, each level increasingly requires faster systems response time which precludes a use of processes that are dependent upon intervention by personnel due to cost and time constraints, systems change is less deferrable due to a direct business profit impact.

23. A framework for analyzing and dissecting applications into a plurality of common elements to serve as a common value proposition foundation for more cost-effective solution-selling by systems vendors, wherein the plurality of common elements comprise at least one of:
a. an application transition from departmental administrative to enterprise administrative that has similar application values and infrastructure resource requirements;
b. an application transition from departmental administrative to departmental business process that has similar application values and infrastructure resource requirements;
c. an application transition from departmental process to enterprise business process that has similar application values and infrastructure resource requirements;
d. an application transition from departmental process to departmental product value that has similar application values and infrastructure resource requirements;
e. an application transition from enterprise administrative to enterprise business process that has similar application values and infrastructure resource requirements;
f. an application transition from enterprise administrative to inter-company administrative that has similar application values and infrastructure resource requirements;
g. an application transition from departmental product value to enterprise product value that has similar application values and infrastructure resource requirements;
h. an application transition from enterprise product value to inter-company product value that has similar application values and infrastructure resource requirements;
i. an application transition from inter-company administrative to inter-company process that has similar application values and infrastructure resource requirements;
j. an application transition from inter-company process to inter-company product value that has similar application values and infrastructure resource requirements;
k. an application transition from enterprise process to enterprise product value that has similar application values and infrastructure resource requirements;
l. an application transition from enterprise process to inter-company process that has similar application values and infrastructure resource requirements.

24. A set of tools for assessing an effect of agility upon a cost effectiveness of an information system to meet at least one need of a business, wherein the set of tools comprise:
a. a first analysis of a distribution of actual cost and amount of time to implement an infrastructure change over a period of time;
b. a second analysis of how many problems had to be identified, managed, and optimized by people in an operation of information systems for last year's ten most potentially disruptive events;
c. a third analysis of ratio of a cost of change to a cost of remaining constant;
d. a fourth analysis of how many separate and sequential people are between awareness and implementation of change;
e. a fifth analysis of how many scarce skill areas are involved between awareness and implementation of change;
f. a sixth analysis of a percentage of time a specification changes more than 20 percent before it is implemented;
g. a seventh analysis of how a first period of time required to identify a problem exceeds a second period of time required to fix the problem; and
h. an eighth analysis of a number of times that a task cannot be done in time no matter how many people are added.
